(19) United States
(12) Patent Application Publication
(10) Pub. No.: US 2023/0133476 A1
(43) Pub. Date: May 4, 2023

(54) Time-Resolved Multi-Gate Ion Sensitive Field Effect Transducer and System and Method of Operating the Same

(71) Applicant: ECOLE POLYTECHNIQUE FEDERALE DE LAUSANNE (EPFL), Lausanne (CH)

(72) Inventors: Adil Koukab, Saint-Sulpice (CH); Jean-Michel Sallese, Pully (CH)

(21) Appl. No.: 17/513,183

(22) Filed: Oct. 28, 2021

(51) Int. Cl. G01N 27/414

(52) U.S. Cl. CPC G01N 27/4145

(57) ABSTRACT

A time-resolved multi-gate ion sensitive field effect transducer, including a silicon layer, a P-doped region in the silicon layer and a first electrode in electric connection with the P doped region, a N-doped region in the silicon layer and a second electrode in electric connection with the N-doped region, a general channel area defined in the silicon layer between the P-doped and N-doped regions, a first gate structure forming a sensing area, the first gate structure including a first insulating layer on the silicon layer, the sensing area configured to receive an electrolyte solution, and a third electrode at the sensing area configured to be in contact with the electrolyte solution, the first gate structure configured to generate a first channel area in the silicon layer for providing a first potential barrier, and a second gate structure configured to generate a second channel area in the silicon layer for providing a second potential barrier.

### FIELD OF THE INVENTION

The present invention is directed to the field of Ion Sensitive Field Effect Transistors (ISFET), and biosensing applications using an ISFET as a detector, and also to the field of lab-on-chip (LoC) designs and applications.

### BACKGROUND

Ion-sensitive field-effect transistors (ISFETs) are transducer that have been used for different types of biosensing applications. For example, the ISFET has been used for applications in a wide range of technologies, such as DNA sequencing, biomarker detection from blood, antibody detection, glucose measurement, and pH sensing. See for example U.S. Pat. No. 8,668,822 or U.S. Patent Publication No. 2005/0156584. Nevertheless, the performances of the ISFET in terms of sensitivity, dynamic range and noise performances are still prohibitive for many applications. The weakness comes from the fact that device works in voltage domain and requires sophisticated analog processing. These limitations are particularly detrimental for low-power low-voltage applications.

Therefore, despite several ISFET based solution for biosensing that are currently available, strongly improved solutions are desired, improving upon sensitivity, ease of operation, and versatility to different application fields.

### SUMMARY

According to one aspect of the present invention, a time-resolved multi-gate ion sensitive field effect transducer (TRISFET) transducer is provided. Preferably, the TRISFET includes a silicon layer, a P-doped region in the silicon layer and a first electrode in electric connection with the P-doped region, a N-doped region in the silicon layer and a second electrode in electric connection with the N-doped region, a general channel area defined in the silicon layer between the P-doped and N-doped regions, a first gate structure forming a sensing area, the first gate structure including a first insulating layer on the silicon layer, the sensing area configured to receive an electrolyte solution, and a third electrode at the sensing area configured to be in contact with the electrolyte solution, the first gate structure configured to generate a first channel area in the silicon layer for providing a first potential barrier; and a second gate structure configured to generate a second channel area in the silicon layer for providing a second potential barrier.

Moreover, according to another aspect of the present invention, the second gate structure of the TRISFET preferably includes a second insulating layer on the silicon layer and a fourth electrode in contact with the second insulating layer, or the second gate structure of the TRISFET preferably includes an electrically charged layer arranged on the silicon layer. Furthermore, according to another aspect of the present invention, the first gate structure is configured to generate a first channel area in the silicon layer at a side of the P-doped region or at a side of the N-doped region for providing a first potential barrier, and conversely, the second gate structure is configured to generate a second channel area in the silicon layer at a side of the N-doped region or at a side of the P-doped region for providing a second potential barrier.

According to another aspect of the present invention, a biosensor system is provided. Preferably, the biosensor system includes a TRISFET transducer, and a controller in operative connection with the first, second, third, and fourth electrodes of the TRISFET transducer via a connection wiring, respectively. Moreover, preferably, the controller is configured to provide for a first, second, third, and fourth voltage to the first, second, third, and fourth electrodes, respectively, and configured to determine a time difference between an application of the first voltage to the first electrode and a predetermined current variation of a current flowing between the P-doped and N-doped regions.

According to yet another aspect of the present invention, a biosensor system is provided. Preferably, biosensor system includes a first TRISFET transducer, a second TRISFET transducer, a controller in operative connection with the first, second, third, and fourth electrodes via a connection wiring of the first TRISFET transducer, respectively, and further in operative connection with the fifth, sixth, seventh, and eighth electrodes via a connection wirings of the second TRISFET transducer, respectively. Furthermore, preferably the controller is configured to determine a time difference between a predetermined current variation of a current flowing between the P-doped and N-doped regions and a second predetermined current variation of a second current flowing between the second P-doped and N-doped regions.

According to still another aspect of the present invention, a method is provided for operating a TRISFET for determining a concentration of an analyte that is suspended in an electrolyte solution. Preferably, the method includes the step of providing for a first, second, third, and fourth voltage to the first, second, third, and fourth electrodes, respectively, and configured to determine a time difference between an application of the first voltage to the first electrode and a predetermined current variation of a current flowing between the P-doped and N-doped regions, and wherein the predetermined current variation includes a change from a first leakage current or off-state current to a second on-state current flowing between the P-doped and N-doped regions. Moreover, the method preferably includes a step of determining an analyte concentration based on the detected time difference.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIGS. 1A to 1I show schematic and simplified cross-sectional views of different embodiments of the device or the system having one or more time-resolved multi-gate ion sensitive field effect transducers (TRISFET), with FIG. 1A showing a first embodiment with the TRISFET 20 exemplarily implemented with silicon on insulator (SOI) technology, FIG. 1B showing aspects of the same embodiment including a controller 10 for controlling different voltages that are applied to the different electrodes 35, 45, 65, 75, and for measuring or sensing a current flowing between the P-doped and N-doped regions 30, 40, and an wide, undoped intrinsic semiconductor region therebetween, also referred to as the general channel area 50, FIG. 1C showing a variant of the first embodiment, where the sensing area 62 is raised above an insulating layer 90 where the gates 72, 98 are formed, and interconnected to the insulting film 69 via electrodes 95, 98 and a conductive layer 99 deposited on the insulating layer 90, FIG. 1D showing a TRISFET for differential-type measurements with two sensing areas 62, 82, one connected to a gate-type structure, and the other one connected to the N-doped region 40, where both the gate 98 and the cathode 40 are connected to perform independent sensing membranes 68, 88 to boost the device sensitivity. Indeed, since the leakage current varies exponentially with gate VG1 and cathode voltage V_{C}, the sensitivity of such implementation is significantly enhanced, FIG. 1E showing another embodiment for differential-type measurements and sensing to the currents between the two different P-doped and N-doped regions 30, 40, 130, 140, including a first and a second TRISFET 20, 120, and having two sensing areas 62, 172 with respective sensing membranes 68, 178, FIG. 1F showing aspects of the same embodiment including a controller 10 for controlling different voltages that are applied to the different electrodes 35, 45, 65, 75, and 135, 145, 165, 175 and for measuring or sensing currents flowing between the P-doped and N-doped regions 30, 40 and between P-doped and N-doped regions 130, 140, FIG. 1G showing an embodiment having an electrically-charged layer 270 as second gate structure 70 arranged on the silicon layer 50 for generating a second potential barrier without the need of an active voltage feeding by a second gate structure 70, FIG. 1H showing a simplified and exemplary block diagram of a system 100 with controller 10 and TRISFET 20, for example the one shown in FIG. 1B, allowing the determine analyte concentrations with a TRISFET 20, including a controller 10, and FIG. 1I show details of an exemplary and simplified electric circuit for the controller 10 that is operating TRISFET 20, including a voltage generation circuit 12, current sensing circuit 14, and timing circuit 16, according to another aspect of the present invention;

FIGS. 2A and 2B show different graphs for illustrating different theoretical and experimental voltages, currents, band diagram, of the TRISFET 20 that is being operated with a controller 10, with FIG. 2A shows, in the lower section, theoretical gate voltage signals VG1, VG2 applied to electrodes 65, 75 of first and second gate structure 60, 70 of a TRISFET 20 to create the electrons and holes barriers inside channel areas 52.1 and 52.2, and also shows voltage VA applied to anode or electrode 35, and voltage VC applied to cathode or electrode 45 to start the charge injection to channel 52, with an upper section of FIG. 2A showing a resulting current I flowing between P-doped and N-doped regions 30, 40 that is initially in an off-state, for example having a relatively small leakage current, and switching over the on-state, the graphs shown as a function of time, FIG. 2B showing a theoretical band diagram of the TRISFET shows the electrons and holes injection barriers (ϕn and ϕp) created by the gate voltages VG1, VG2 before current switching (t<tch as shown in FIG. 2A), and with an illustration of the impact of the analyte in the electrolyte solution 61 of the sensing area 62 on the holes barrier Δϕp, and it can be seen that the potential barriers collapse after a certain time (t>tch) when the accumulated charges under first and second gate structure 60, 70 reach the threshold level Qref;

FIG. 3 shows a top view of an exemplary layout of an exemplary TRISFET 20 that has been fabricated for experimental and testing purposes, showing the different gate electrodes 65, 75 as square shaped elements, and the two anode and cathode electrodes 35, 45;

FIG. 4A to 4D showing different simulation results of the TRISFET 20 of Technology Computer-Aided Design (TCAD) using the Sentaurus™ device simulation software, with the exemplary and non-limiting parameters of the TRISFET 20 being tₛₒᵢ=250 nm, L_{gates}=3 μm, tₒₓ=4 nm, with FIG. 4A and FIG. 4B showing the electrostatic potential, FIG. C showing the switching currents and FIG. 4D showing the densities of electrons and holes under respectively the first and second gate structure 60, 70, before and after triggering. The simulated curves are obtained for gate voltage VG1=1.2, cathode voltage VC=0.8v, anode voltage VA=−0.8V, and gate voltage VG2 varying from −1.2V to −1.2004 V with a step of 0.1 mV;

FIGS. 5A and 5B showing different exemplary circuits for the readout of TRISFET system having two TRISFET 20, 120, labelled as TRISFET_a and TRISFET_b, with FIG. 5A showing a current sensing and a timing circuit with two TRISFET devices 20, 120 symbolized as diodes that are connected in series to a respective quenching and reset circuit DQ, and FIG. 5B showing an exemplary time-to-digital converter circuit to convert the time signals to a digital value that can be read by a microprocessor.

Herein, identical reference numerals are used, where possible, to designate identical elements that are common to the figures. Also, the images are simplified for illustration purposes and may not be depicted to scale.

### DESCRIPTION OF THE SEVERAL EMBODIMENTS

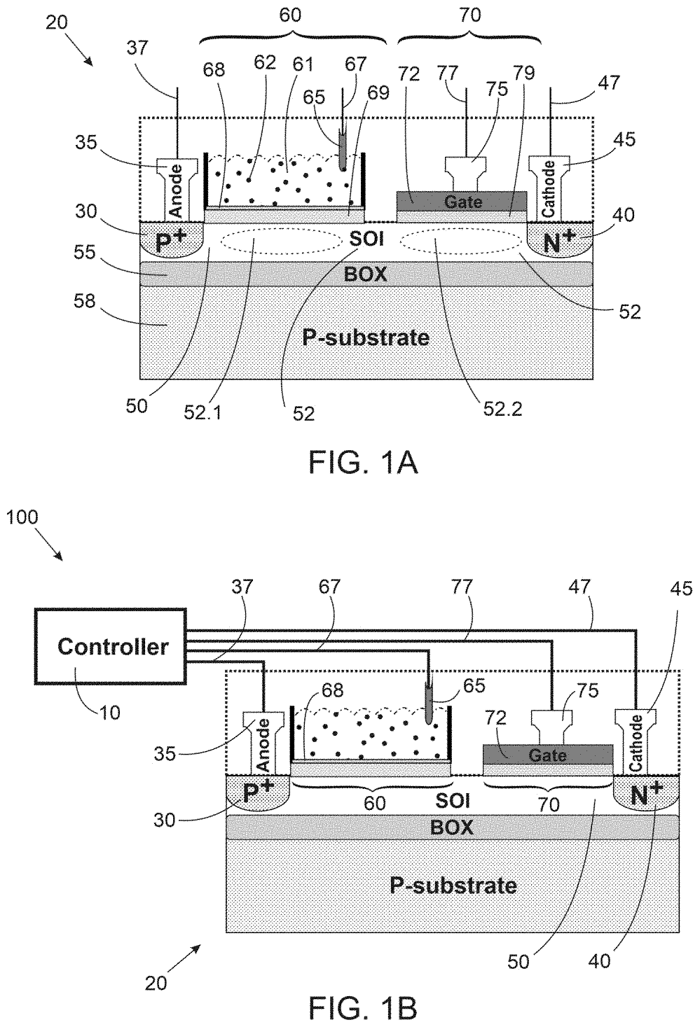

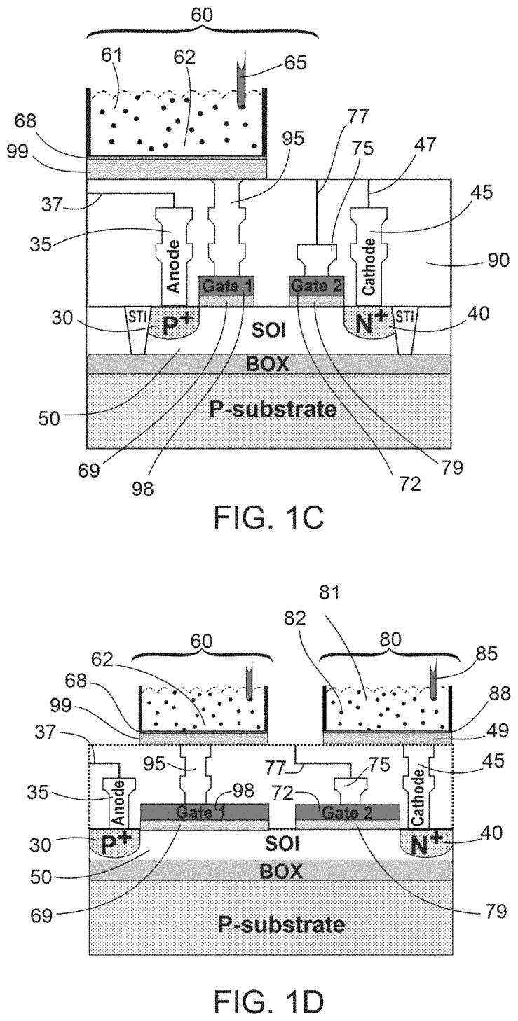

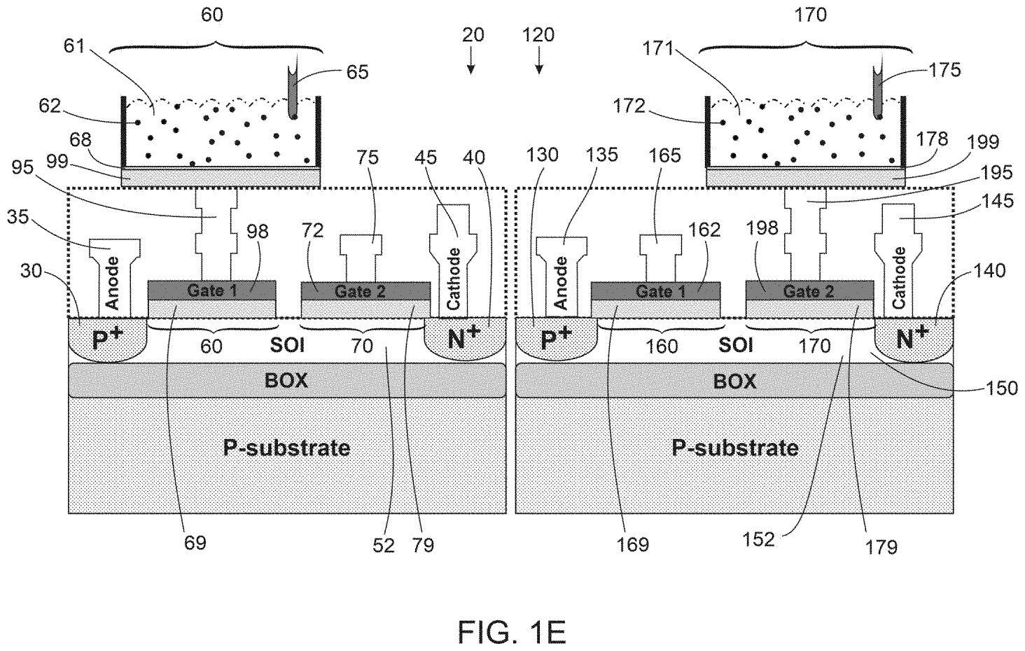

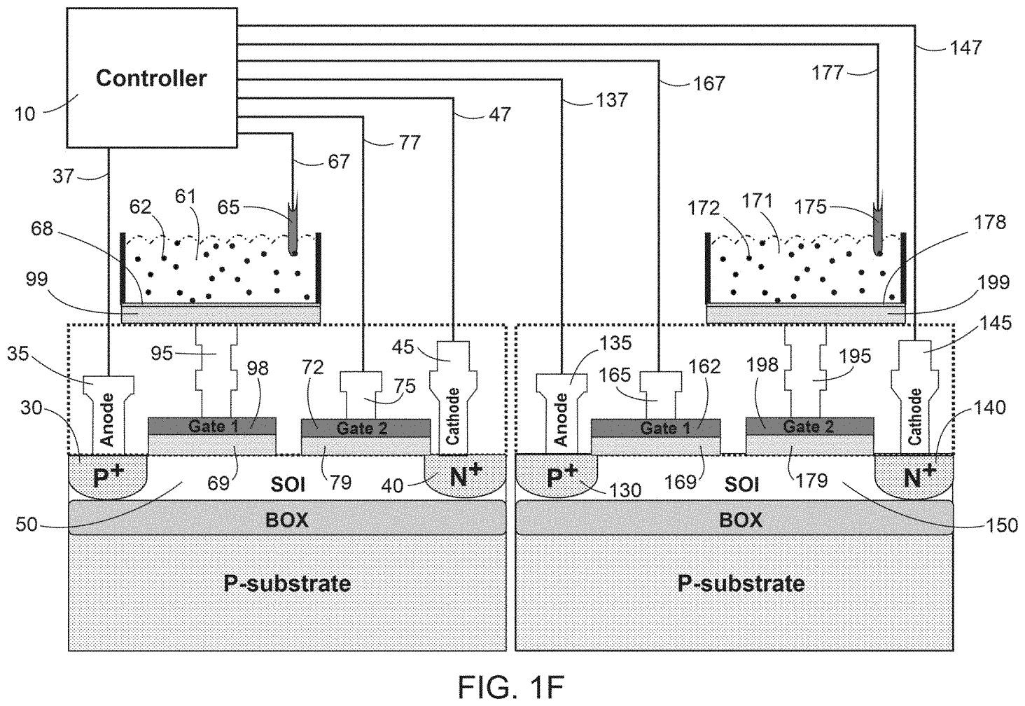

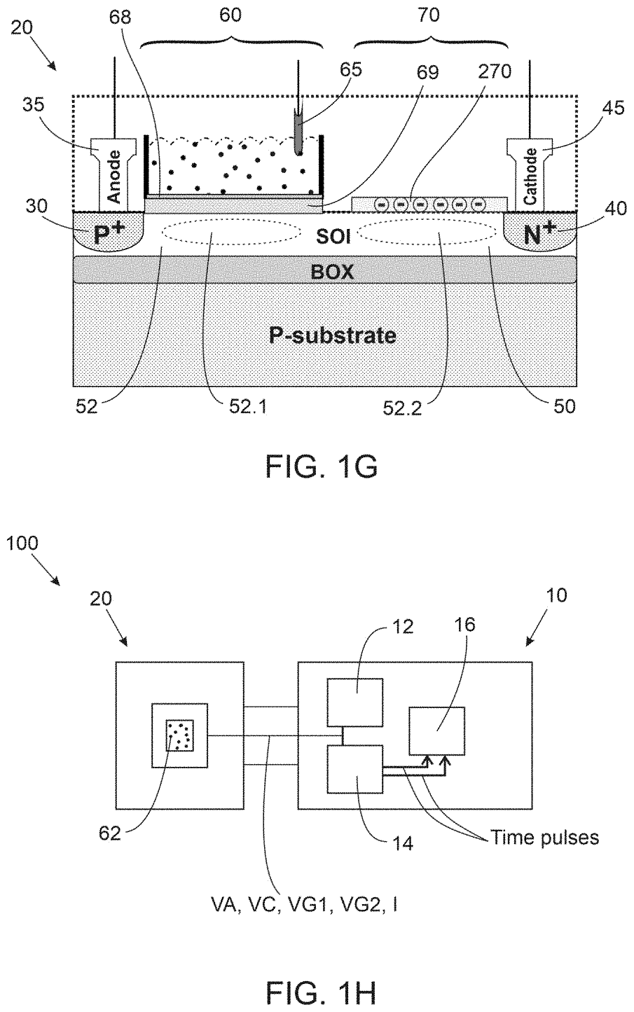

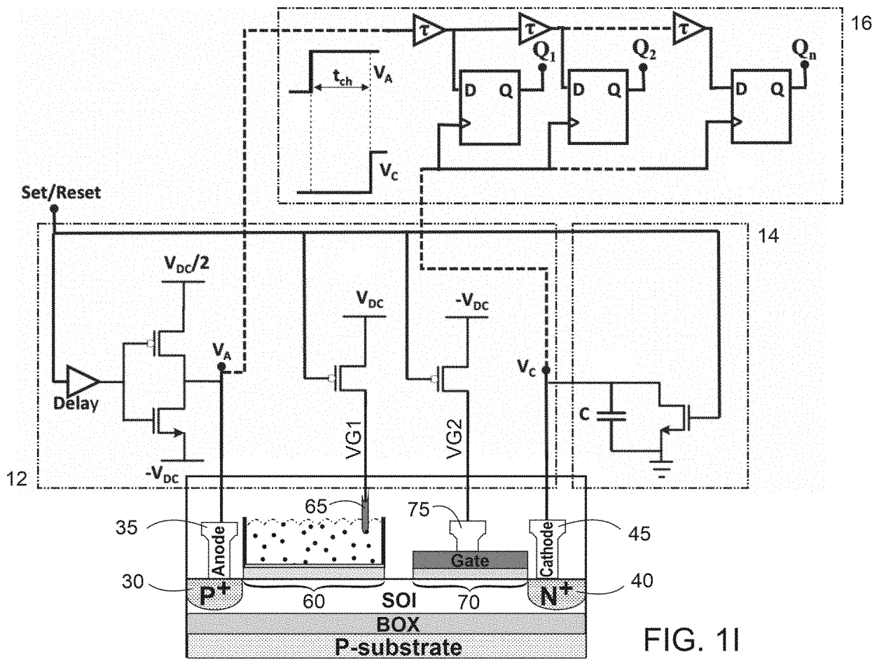

FIG. 1A shows a schematic and simplified view of a time-resolved multi-gate ion sensitive field effect transducer (TRISFET) 20, according to one aspect of the present invention, for example operable as an electrochemical transducer. The TRISFET device 20 preferably includes a substrate that has a silicon layer 50 serving as the channel region 52 for a diode structure, between a P-doped region 30 as an anode and a N-doped region 40 as a cathode. The variant shown is based on a silicon-on-insulator (SOI) manufacturing technology, showing a p-based substrate, a buried oxide layer (BOX) as an insulator, and thereafter the silicon layer serving as the general channel region or area 52, between a PIN-junction that would be formed by the PIN diode structure of the P-doped region 30 and the N-doped region 40, and the wide, undoped intrinsic semiconductor region that forms the general channel area or region 50. The P-doped region 30 in the silicon layer 50 is electrically connected to a first electrode 35, and the N-doped region 40 in the silicon layer 50 is electrically connected to a second electrode 45, and the general channel area or region 52 is defined in the silicon layer 50 between the P-doped and N-doped regions 30, 40. Two different gate structures 60, 70 are present in an insulating layer 90 that allow to generate different potential barriers in the general channel area 52, with a first gate structure 60 forming a sensing area 62 in the form of a volume, opening, channel, well, groove, or reservoir, or other type of opening that can accommodate an electrolyte solution 61 having an analyte therein that is to be analyzed by the TRISFET 20, and a second gate structure 70 arranged next to the first gate structure 60, when viewed along an axis of extension general channel area or region 52.

The first gate structure 60 can include a first insulating layer 69 on the silicon layer 50, and analyte sensing membrane 68 formed thereon, and analyte membrane 68 can be functionalized with tailored bio-recognition elements, to form a sensing surface. For example, such functionalization can allow to test antibodies against the viral/bacteria-related antigens for immuno-sensors, complementary DNA/RNA probes against the genomic material of the pathogen for geno-sensors or tailor-made aptamers for apta-sensors. See for example Panahi et al., “Recent Advances of Field-Effect Transistor Technology for Infectious Diseases,” Biosensors, Vol. 11, No. 4, p. 103, year 2021, https://doi.org/10.3390/bios11040103.

The sensing area 62 can include a volume that is configured to receive an electrolyte solution 61, and a third electrode 65 at the sensing area 62 configured to be in contact with the electrolyte solution 61, for example by protruding down into the volume of the sensing area 62 serving as a reference electrode, such that electrode 65 can provide for an electric signal to electrolyte solution 61 that is located within sensing area 62. With the first gate structure 60, upon application of a first gate voltage VG1 thereto, a first subchannel area or region 52.1 can be generated in general channel area 52 of silicon layer 50, to establish a first potential barrier therein. Moreover, in the embodiment of FIG. 1A, the second gate structure 70 includes a second insulating layer 79 in contact with silicon layer 50, and a fourth electrode 72, 75 in contact with the second insulating layer 79, for example a plate-like electrode 72 to generate a second subchannel area or region 52.2 can be generated in general channel area 52 of silicon layer 50, next to the first subchannel area or region 52.2, but in proximity to N-doped region 40, to generate a second potential barrier therein.

In the embodiment shown in FIG. 1A, the first gate structure 60 and the corresponding formation of the first subchannel area or region 52.1 is at a side of the p+ anode region 30, while the second gate structure 70 and the corresponding formation of the second subchannel area or region 52.2 is at a side of the n+ cathode region 40. However, this is only an example, and it is also possible that the positions of gate structures 60, 70 are inversed, for generating the first subchannel area or region 52.1 at a side of the n+ cathode region 40 from the electrolyte solution, and for generating the second subchannel area or region 52.2 at the p+ anode region 30.

In other words, TRISFET 20 includes a PIN or P-I-N type diode with an exemplary p+ anode region 30, n+ cathode region 40 and gate oxide regions 60, 70, herein first and second gate structure 60, 70, and these gates configured to control the current I flowing in general channel area 50, more specifically in the silicon-on-insulator (SOI) general channel area 50, and the SOI channel 50 can be intrinsic or lightly doped. Preferably, one of the gate oxide regions, in this case the first gate structure 60, is in contact with an electrolyte solution 62 through a sensing-membrane 68 and is biased with third or reference electrode 65 that can be configured to be immersed in electrolyte solution 62. As a non-limiting example, volume or opening 61 that can hold or otherwise contain electrolyte solution 62 can be embodied as a sink or groove having a top open area for receiving fluids by microfluidic dispensing of solutions to be analyzed with a pipette tip, or can be connected to a fluidic system with valves, ducts, channels, and purging devices for delivery and evacuation of the electrolyte solution 62 from volume or opening 61.

According to another aspect of the present invention, a TRISFET system or device 100 is provided, including the herein described TRISFET 20, and further including a controller 10, for example device for providing voltage signals to TRISFET 20, and for sensing, measuring, or otherwise reading current I that flows between P-doped region 30 or anode and N-doped region 40 or cathode of PIN junction, through the wide, undoped intrinsic semiconductor region that forms the general channel area or region 50, as shown in an simplified schematic in FIG. 1H. For example, the controller 10 can be in operative connection with the first, second, third, and fourth electrodes 35, 45, 65, 75, via a connection wiring 37, 47, 67, 77, and the controller 10 can include a voltage generation circuit 12 that is configured to provide for a first voltage, as an anode voltage VA via first electrode 35 to P-type region 30, a second voltage, as a cathode voltage VC via second electrode 45 to N-type region 40, a third voltage, as a first gate voltage VG1 via third electrode 65 through electrolyte 62, and fourth voltage, as a second gate voltage VG2 via fourth electrode 75, to thereby provide for a an anode voltage VA, a cathode voltage VG, a first gate voltage VG1, and a second gate voltage VG2. In addition, controller 10 can further include a current sensing circuit or device 14 and a timing circuit or device 16 that is configured to determine a time difference between an application of the first voltage VA to the first electrode 35 or anode, and a predetermined current variation of current I flowing between the P-doped and N-doped regions 30. For example, with current sensing circuit 14, it is possible to detect, sense, or measure a predetermined current variation of current I from a first leakage current or off-state current, to a second on-state current flowing between the P-doped and N-doped regions 30, 40, to measure a timing of the breakdown of the first and second potential barriers that are located in the first and second subchannel areas 52.1, 52.2 of general channel area 50 of intrinsic semiconductor region.

For example, with voltage generation circuit 12 of controller 10, it is possible to provide for the first voltage VA to the P-doped region 30 or anode and provide for the second voltage VC to the N-doped region 40 or cathode, the first and second voltages VA, VC configured to polarize the P-doped region 30 to a potential that is higher a potential of the N-doped region 40, thereafter provide for the third voltage VG1 at the third electrode 65 of first gate structure 60 to generate a first potential barrier in a first channel area 52.1 in the silicon layer 50 at the first gate structure 60 via the electrolyte solution 61, the first potential barrier opposing a passage of charge carriers emitted from the P-doped region 30, and provide for the fourth voltage VG2 at the fourth electrode 72, 75 of the second gate structure 70 to generate a second potential barrier in second channel area 52.2 in the silicon layer 50 at the second gate structure 70, the second potential barrier opposing a passage of charge carriers emitted from the N-doped region 40.

Also, with current sensing circuit or device 14 and a timing circuit or device 16, it is possible that the current sensing device 14 is configured to sense or measure the current between the P-doped and N-doped regions 30, 40, flowing in silicon layer 5, and a timing device 16 that is configured to measure or determine the time difference between an application of the first voltage VA to the first electrode 35 and P-doped region and the predetermined current variation of the current I flowing between the P-doped and N-doped regions 30, 40, the predetermined current variation caused by gradual accumulation of charge carriers in a first channel area 52.1 in and second channel area 52.2 in the silicon layer 50, leading to a disappearance of the first and second potential barriers.

As a non-limiting example, a method of operation of the TRISFET 20 is provided, for example with the system 100 as shown in FIG. 1B and schematically shown in FIG. 1H, and with FIG. 1I showing an exemplary and simplified circuit implementation, having a controller 10 with a voltage generation circuit 12 and a current sensing circuit or device 14 and a timing circuit or device 16.

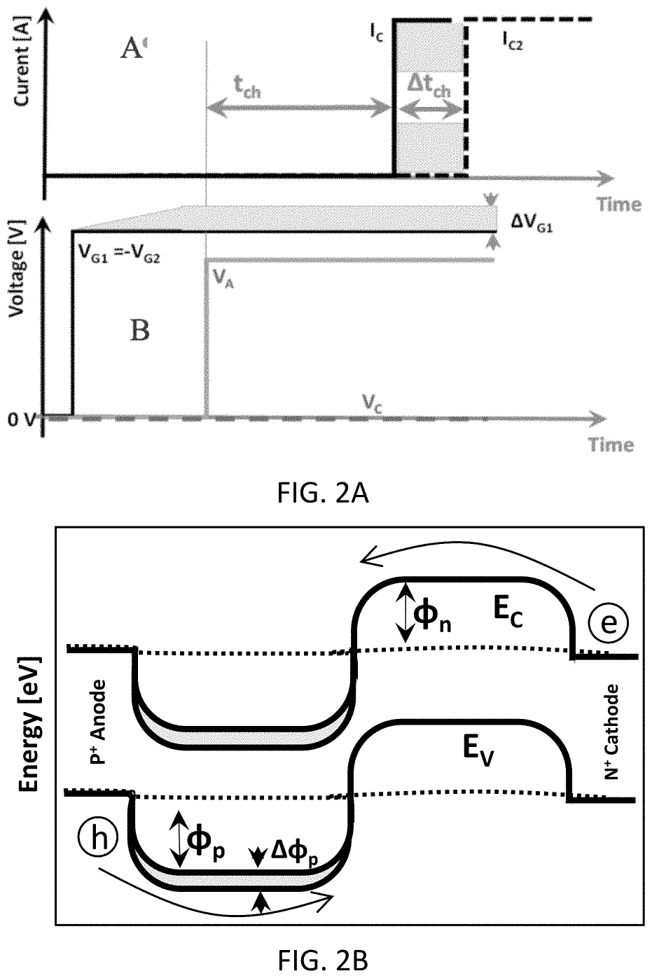

A first step can be performed where the first gate structure 60 is positively biased through the reference electrode 65 with a voltage VG1, and where second gate structure 70 is negatively biased with a voltage VG2, as for example seen in the graphs of FIG. 2A, for example such that VG1 is equal to negative −VG2. For example, a voltage circuit 12 can be used as shown in FIG. 1I, where a DC supply voltage VDC and −VDC can be provided, for example to third and fourth electrodes 65, 75 via a respective pMOS transistor that is switched on during “Set Mode” and switched off during “Reset Mode”. These voltage biases by VG1, VG2, create potential barriers ϕp and ϕn that block respectively holes coming from anode of P-doped area or region 30 and electrons coming from cathode of N-doped area or region 40, as shown in in the band diagram of FIG. 2B. In this mode, the TRIFET 20 emulates a lateral PNPN thyristor behavior, but without any channel doping. To eliminate these barriers a certain amount of charge Qref would need to be accumulated under the two gate oxide regions, for example in the first and second subchannel 52.1 and 52.2, respectively. Here, the level of Qref is controlled by the first and second gate voltages VG1 and VG2. Because the potential at sensing membrane 68 that is in contact with an electrolyte solution 61 in sensing area 62 changes with the analyte concentration, the potential influences the charges that are accumulated at first subchannel 52.1 in the silicon layer 50 via insulating layer 69 as shown in the example of FIG. 1A, or also for example via electrodes 95, 98 and conductive layer 99, via insulating layer 69, as shown exemplarily in FIG. 1C, and thereby the charge level Qref.

FIG. 1D shows an example of a TRISFET 20 where both Gate 1, for example formed by electrodes 95, 98, and the cathode 40 with second electrode 45 are connected to perform independent sensing membranes 68, 88 to boost the device sensitivity, having two sensing areas 62, 82. Sensing area 82 that includes sensing membrane 88 is interconnected via conductive layer 49, second electrode 45 to cathode or N-type region 40. Because the leakage current varies exponentially with the gate and the cathode voltage, the sensitivity of such implementation is significantly enhanced.

FIG. 1E shows another implementation where two TRISFETs 20, 120 are working in differential mode, with FIG. 1F showing the controller 10 for operating the TRISFET 20, 120 in the differential mode. The positions of the sensing membranes 68, 178, conductive layers 99, 199, and sensing areas 62, 172 are complementary, with sensing area 62 operatively associated with Gate 1 or gate 98 at TRISFET 20, and sensing area 172 operatively associated with Gate 2 or gate 198 at TRISFET 120. Thereby, if the chemical interactions at the electrolyte-solution 61 result in delayed current pulse of TRISFET 20, it will have a counter effect by electrolyte solution 171 on Gate 2, and thereby this will accelerate the occurrence of the current pulse of TRISFET 120. The measurement of the time difference between these two current pulses will return a very precise evaluation of the analyte concentration. The expected response is highly amplified since the two membranes have an exponential impact on the leakage currents, and thereby on the differential triggering time. In addition, the differential mode can also be used for the common-mode rejection and temperature drift cancellation.

After setting the potential barriers in the first and second subchannels 52.1 and 52.2, in a next step of the method the P-I-N diode formed by p-type region 30, N-type region 40, and silicon-on-insulator (SOI) general channel area 50 is forward biased by applying a positive voltage VA on the anode 30 via first electrode 35 while keeping the voltage VC on cathode 40 grounded or zero, as shown in FIG. 2A. For example, a voltage circuit 12 can be used as shown in FIG. 1I, where a DC supply voltage V_{DC}/2 can be provided, for example to the first electrode 35 via a respective pMOS transistor that is switched on after a certain delay during set mode and switched off during “Reset Mode”. Holes start then to be injected from anode 30 to cathode 40 and part of them will accumulate under the area of first gate structure 70, in second subchannel area 52.2. Simultaneously, electrons are injected from cathode 40 to anode 30 and part of them will accumulate under first gate area 60 at first subchannel area 52.1, as illustrated in FIG. 2B. The accumulation of these charges results in the lowering of these two potential barriers. This will in turn accelerate the injection of carrier and their accumulation. Barriers will lower again, and after a certain time tch, when the accumulated charge Qac arrive to the threshold level Qref, a positive feedback is triggered and a sharp switching output current is generated, where the PIN diode switched from the off-state to the conducting on-state, as illustrated in the upper section of FIG. 2A. As shown in the upper section of FIG. 2A, the current I detected or sensed by current sensing device 14 is shown.

For example, with the exemplary circuit for current sensing device 14 shown in FIG. 1I, at triggering time, the sharp variation of I_{c} charge the capacitor C and results in a sharp voltage variation V_{c}, and this voltage signal can be provided to timing circuit or device 16 and compared against a timing of voltage pulse of V_{A} at the anode 30. The input time interval t_{ch} between the rising edges of a V_{A} and V_{C} stop pulse can be measured using a tapped delay line with well-defined delay times T and a series of D-flip-flop cells, of timing circuit 16. The start signal V_{A} propagates through this line and is delayed by a certain number of the delay line and D-flip-flop cell pairs. On the arrival of the stop signal V_{c}, the delayed versions of the start signal are sampled by the flip-flops. All delay stages which have been already passed by the start signal give a high or “1” value at the outputs of their flip-flops, all delay stages which have not been passed by the start signal yet give a low or “0” value. The resulting digital thermometer code (Q₁, Q₂, . . . Qₙ) at the output of the series of D-flip-flops is therefore a measure for the time interval t_{ch}, and can be further read and processed by a data processor, for example a microcontroller, microprocessor, or other data processing device. During “Reset Mode”, a DC supply voltage −V_{DC} and 0V can be provided, for example to the first and second electrodes 35 and 45 via a respective nMOS transistor that is switched on. This will reverse bias the P-I-N diode formed by p-type region 30, N-type region 40, and silicon-on-insulator (SOI) general channel area 50 and discharge the capacitor C.

At the beginning, charges are blocked by the barriers formed by the first and second subchannel regions 52.1 and 52.2, and only part of them are injected and further accumulate under first and second gate structures 60, 70. Only a leakage current in the pA range is detected at this point. After a certain time tch, when the accumulated charges reach the threshold level Qref, a positive feedback is triggered. If the analyte concentration shifts third voltage or first gate voltage VG1 by ΔVG1, the measured tch will also be shifted in proportion to Δtch. Measuring Δtch requires is performed by the timing circuit or device 16, requiring a specific precision and measurement resolution to provide for a very accurate information on the analyte concentration of solution 62. A possible way to measure the current I is to place a quenching and reset circuit (DQ) into a current flow path of PIN diode.

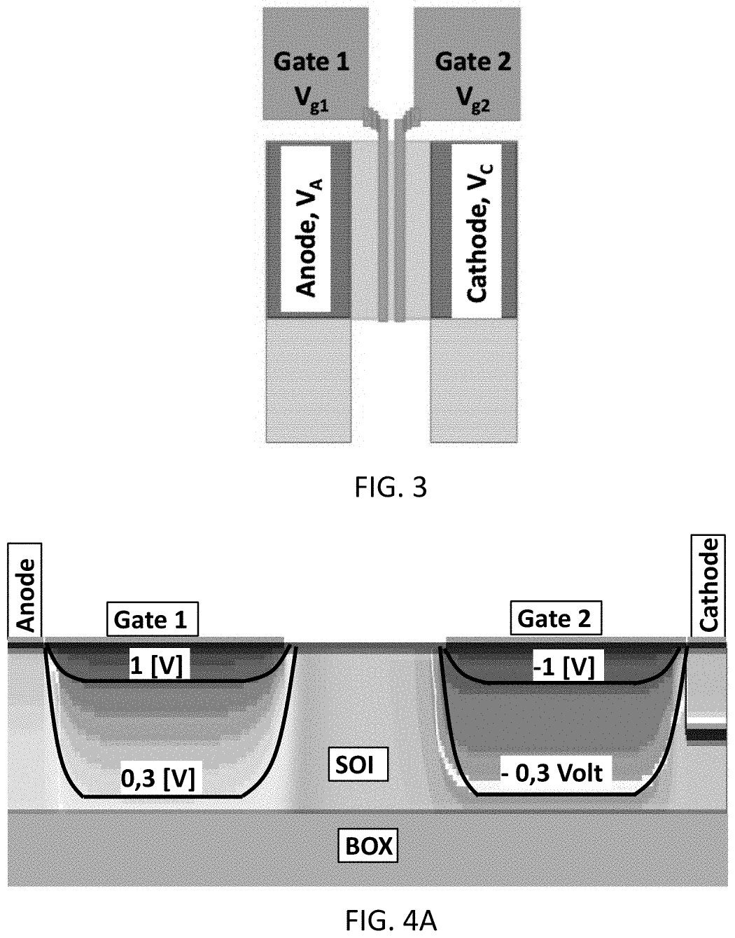

Experimental results have been performed with a prototype of the TRISFET device 20, based on the embodiment shown in FIG. 1A. A commercial SOI wafer was used and different TRISFET 20 with different sizes and geometries were fabricated. To be conservative, the oxide thickness chosen for these first devices was quite high, more than 10 nm. A top view of an exemplary embodiment is shown in FIG. 3. The sharp switching of current I through the PIN diode could be confirmed experimentally, when VG1 and VG2 were switched from 0V to 4 V and −4 V respectively. The objective was to create sufficiently high electrons and holes barriers. The relatively high values of the gate voltages VG1 and VG2 used are due to the relatively large thickness of the oxide that is above 10 nm. Afterward the anode voltage VA was switched from 0 to 1.2 V while the cathode voltage VG was maintained at 0V. Despite the forward biasing of the diode, only a small charge flow was injected and then accumulated under the gate structures 60, 70. This can explain a low leakage current at the beginning. After a t_{ch}=12 ms, the accumulated charges reached a certain threshold that lower sufficiently the barriers. A positive feedback was then triggered and a sharp switching output current I was generated. The experiment was repeated for different gate voltages VG1. When first gate voltage VG1 was increased by 20 mV, the measured t_{ch} was shifted by about 1 ms. This voltage to time conversion ratio is very substantial. With a timing measurement circuit 16 that has a small time resolution, for example in the picosecond range, it is possible to implement a time-to-digital converter that can measure current time variations in the range of picoseconds which for TRISFET 20 corresponds to an extremely small variations of the applied gate voltage VG1, and thus an infinitesimal change in the analyte concentration. This provided for a good estimate about its potential in terms of electrochemical sensitivity. See for example, Mandai et al., “1.0 ps Resolution Time-to-Digital Converter Based-on Cascaded Time-Difference-Amplifier Utilizing Differential Logic Delay Cells,” IEICE Transactions on Electronics, Vol. 94, No. 6, year 2011, pp. 1098-1104.

During experimental tests and the achieved results, the TRISFET 20 was initially blocked at a low anode voltage VA and turned ON sharply as VA reaches a certain threshold level Vth. When anode voltage VA sweeps back to 0, the TRISFET device 20 behaves like a classical diode. It stays in the ON state until anode voltage VA decreases below Uj≈0.7 V, at which voltage it turns off. It has also been shown that Vth is linearly dependent on gate voltage VG with a gain close to one. This shows that the conversion of ΔVG to ΔVth take place without any amplification, and thus the potential of this component as a transducer in voltage domain would be very weak.

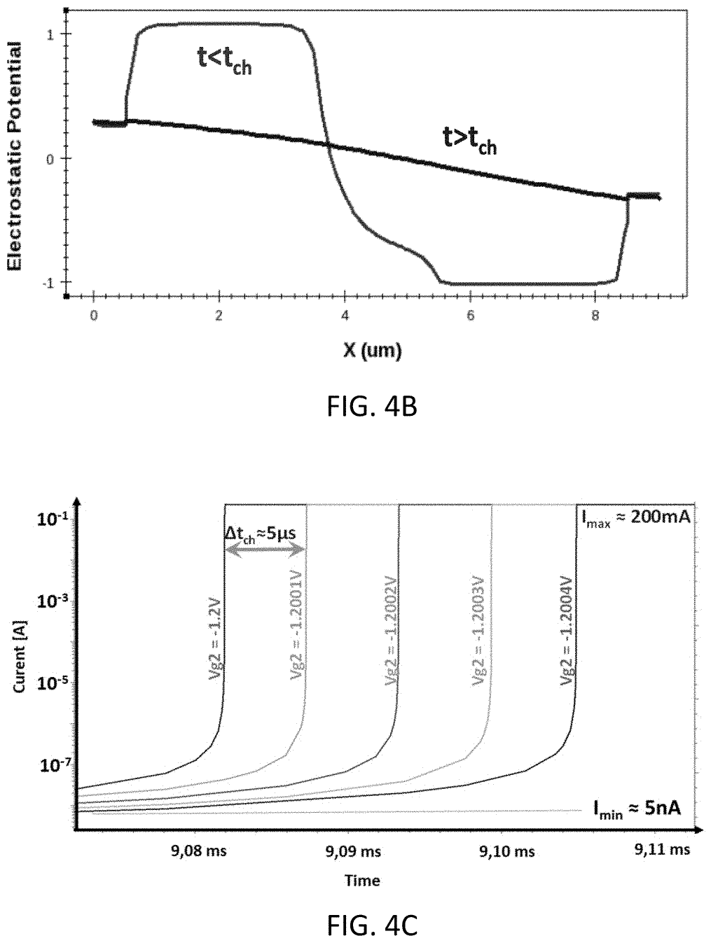

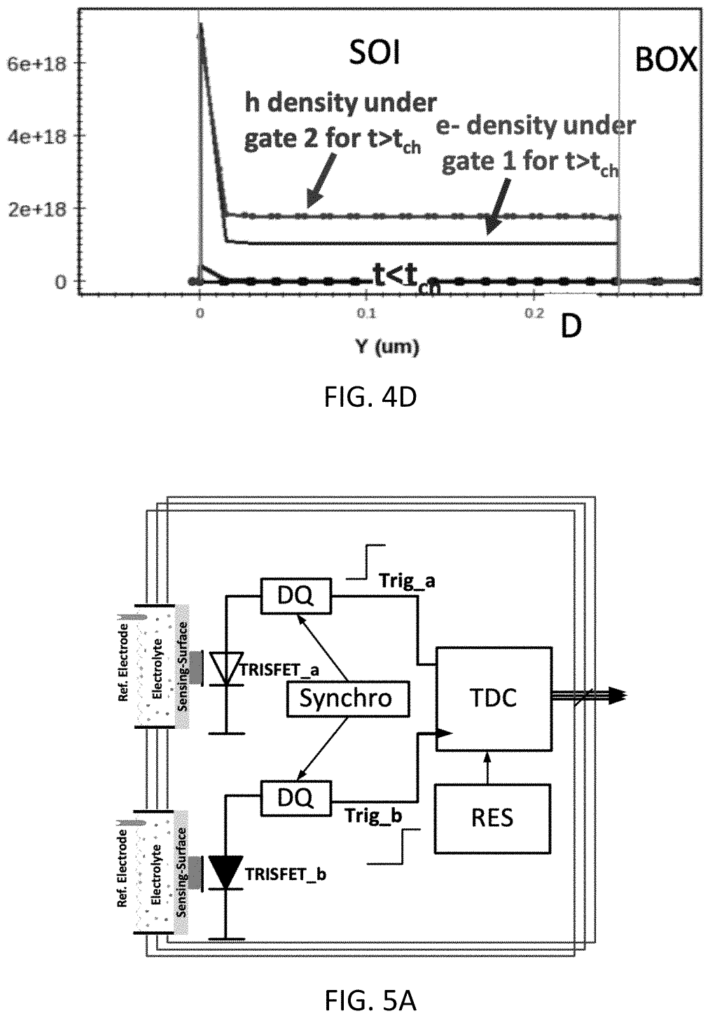

FIG. 4A to 4D showing different simulation results of the TRISFET 20 of Technology Computer-Aided Design (TCAD) using the Sentaurus Device simulation software, with the exemplary and non-limiting parameters of the TRISFET 20 being tₛₒᵢ=250 nm, L_{gates}=3 μm, tₒₓ=4 nm, with FIG. 4A and FIG. 4B showing the electrostatic potential, FIG. C showing the switching currents and FIG. 4D showing the densities of electrons and holes under respectively the first and second gate structure 60, 70, before and after triggering. The simulated curves are obtained for gate voltage VG1=1.2, cathode voltage VC=0.8v, anode voltage VA=−0.8V, and gate voltage VG2 varying from −1.2V to −1.2004 V with a step of 0.1 mV.

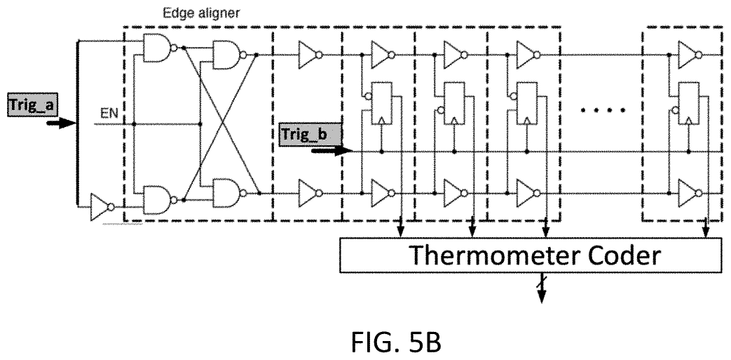

FIGS. 5A and 5B show schematic and simplified views of a possible implementation of the differential-mode biosensor as shown in FIGS. 1E and 1F, with FIG. 5A showing a current sensing and a timing circuit with two TRISFET devices 20, 120, labelled as TRISFET_a and TRISFET_b, symbolized as diodes that are connected in series to a respective quenching and reset circuit DQ that are synchronized, and FIG. 5B showing an exemplary time-to-digital converter circuit for counting a time difference between the two trigger circuits, to convert the time signals to a digital value that can be read by a microprocessor. TRISFET_a and TRISFET_b forming an individual measuring cell, and will have sensing membranes deposited in complementary configurations, for example, time-to-positive feedback will be advanced for TRISFET_a and delayed for TRISFET_b. By tracking the triggering time difference between these two TRISFET diodes, a precise evaluation of the targeted analyte concentration will be obtained using time-to-digital converters (TDC). The output digital signal of each measurement cell of an array of measurement cells can thereafter be memorized and sent to data processing device, for example a PC, MacIntosh computer, smart phone, tablet, having a user interface, for example a display device, monitor, computer screen, for further evaluation. An active quenching, active reset (AQAR) can be used as the DQ circuit for the diodes. FIG. 5B is an example of a simple and smart topology that can be used as TDC. The triggering signal of the TRISFET_a, referred to as Trig_a, can be passed differentially through a chain of inverters acting as delay elements. The delayed vectors at the output of the inverters are sampled by an array of flip-flops on the rising edge of the triggering signal referred to as Trig_b, coming from the TRISFET_b. The flip-flops need to be designed to have a metastability window that should be much smaller than inverter delay. The Q outputs of the flip-flops are then passed to thermometer-coder, giving the information on the timing separation between the rising edges of Trig_a and Trig_b in a binary form. The time resolution (LSB) in this architecture is equal to the inverter delay for the given technology, which is as small as 40 ps in a 0.13 μm SOI-CMOS. The required characteristics in terms of number of bits, resolution (dynamic range), linearity speed and compactness will be defined and translated into blocks, sub-blocks and circuits design.

In sum, according to some features of the herein described TRISFET device 20, system 100, and method, it is possible to provide the best-in-class alternative to ISFET type transducers with the potential to become the first choice for lab-on-chip (LoC) technology, and point of care (PoC) devices. As for ISFET, the herein described TRISFET 20 and the corresponding systems having one or more TRISFETs, and operation methods thereof, it is possible to sense the variation in the charge density of a surface, for example a surface of sensing membrane 68 that is in contact with a liquid having specific molecules dispersed therein, for example an electrolyte liquid. However, in contrast with common approaches, the herein proposed TRISFET, an operation in the time domain can be done where a timing of current and voltage changes can be sensed, and thereby requires no analog signal processing. The component concentrates in a single device many built-in functionalities: a tunable threshold for the charge, an ion sensitive current generator, a charge integrator and an almost ideal sharp switching comparator. The detection starts by setting the charge threshold to a certain level. In a second step, the current I is switched on and the transducer starts accumulating an extra charge coming from a leakage current. When the integrated charge reaches the threshold level, a positive feedback is triggered and a sharp switching output signal is generated. A small variation in the number of biomolecules captured at sensing membrane 68 results in huge variation of the charging current, thereby accelerating proportionally the accumulation of charge and thus reducing the triggering time of the comparator. A simple Time to Digital Converter (TDC) as a timing device 16 can be used to precisely determine the concentration of the analyte, a true asset for the circuit in terms of complexity and reliability. The strong positive feedback of the transducer makes the signal switching extremely sharp in time domain which improves the time precision, the immunity against jitter noise and enhances dramatically the sensitivity. The TRISFET 20 is also quite versatile, allows a wide range of configurations and tunings and is fully compatible with commercial SOI-CMOS technology.

With the herein described TRISFET device 20, systems including such TRISFET 20, or differentially operated TRISFET 20, 120, and methods of operation, a strongly improved sensing transducer can be provided, for a potentiometric biosensor. The TRISFET 20 can be adapted to different applications by chemists and biologists after a proper functionalization of the sensing membrane 68. For example, an array of biosensors that are based on the TRISFET 20 can be provided for multiple sensing, for different applications, for example for DNA sequencing as further described below. It is even possible that the herein presented TRISFET 20, and its technology could have a broader impact in society, public health and economy. Without being exhaustive, hereafter are some of these applications that can use the TRISFET 20.

Point of Care devices (PoC): PoC are handheld, battery powered devices dedicated to rapid diagnostic tests at or near the place where a specimen is collected. They are widely used for massive screening tests of the population and prove to be essential in epidemic and pandemic prevention and control. They can also optimize diagnosis, triage, and patient monitoring during disasters. Thanks to its expected low power, low noise, low cost and very high sensitivity, TRISFET 20, 120 has the potential to be a key sensor for PoC devices.

DNA sequencing: A fundamental tool in the identification of pathogens, for example a virus, bacteria, Fungi, is genome sequencing that enabled the biologists to identify rapidly SARS-CoV-2 and to follow the evolutions of its new variants. Improving the sensitivity of the biosensors used for DNA sequencing will certainly help biologists and chemists to better understand emerging pathogens and their interactions with humans, animals and plants in various environments. More specifically, the expected low footprint of the herein presented TRISFET 20 its low power consumption and compatibility with CMOS technology, and its expected unprecedented sensitivity fit very well with a low cost multi-arrays implementation for fast paralleled DNA sequencing.

Water and food quality control, environmental monitoring: Because the first and most efficient application of the ISFET technology was pH-sensing, the technology was intensively used in food control. The applications of ISFET as a sensor in environmental monitoring is quite recent. It includes environmental protection, water safety, pesticide detection, toxicity analysis, and more. In these applications, distributed ISFET sensors can detect and measure various chemical species in a large environment and communicate the information through wireless sensor networks or using internet of things (“IoT”) technology. Here as well, the expected low power consumption and ultra-sensitivity of TRISFET will be is a true asset.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

1. A time-resolved multi-gate ion sensitive field effect transducer (TRISFET) including,
a silicon layer,
a P-doped region in the silicon layer and a first electrode in electric connection with the P-doped region,
a N-doped region in the silicon layer and a second electrode in electric connection with the N-doped region, a general channel area defined in the silicon layer between the P-doped and N-doped regions,
a first gate structure forming a sensing area, the first gate structure including a first insulating layer on the silicon layer, the sensing area configured to receive an electrolyte solution, and a third electrode at the sensing area configured to be in contact with the electrolyte solution, the first gate structure configured to generate a first channel area in the silicon layer for providing a first potential barrier; and
a second gate structure configured to generate a second channel area in the silicon layer for providing a second potential barrier.

2. The TRISFET according to claim 1, wherein the second gate structure includes a second insulating layer on the silicon layer and a fourth electrode in contact with the second insulating layer.

3. The TRISFET according to claim 1, wherein the second gate structure includes an electrically charged layer arranged on the silicon layer,

4. The TRISFET according to claim 1, wherein the first gate structure is configured to generate the first channel area in the silicon layer at a side of the P-doped region or the N-doped region for providing the first potential barrier, and the second gate structure is configured to generate the second channel area in the silicon layer at a side of the N-doped region or the P-doped region for providing a second potential barrier.

5. The TRISFET according to claim 1, further comprising a functionalized layer or a surface of the first insulating layer being functionalized for an effective analyte recognition of an analyte in the electrolyte solution, the functionalized layer or the functionalized surface of the first insulating layer being in contact with the electrolyte solution when located in the sensing area.

6. The TRISFET according to claim 1, wherein the first gate structure includes a third insulating layer, as second gate electrode, and an electric interconnection between the second gate electrode and the third insulating layer.

7. The TRISFET according to claim 1, further comprising:
a second sensing area that includes a third insulating layer in contact with the second electrode, the second sensing area configured to receive a second electrolyte solution, and a fifth electrode configured to be in contact with the second electrolyte solution.

8. A biosensor system comprising:
a TRISFET according to claim 2, and
a controller in operative connection with the first, second, third, and fourth electrodes via a connection wiring of the TRISFET, respectively,
wherein the controller is configured to provide for a first, second, third, and fourth voltage to the first, second, third, and fourth electrodes, respectively, and configured to determine a time difference between an application of the first voltage to the first electrode and a predetermined current variation of a current flowing between the P-doped and N-doped regions.

9. The biosensor system according to claim 8, wherein the predetermined current variation includes a change from a first leakage current or off-state current to a second on-state current flowing between the P-doped and N-doped regions.

10. The biosensor system according to claim 8, wherein the controller comprises a voltage generation circuit that is configured to
provide for the first voltage to the P-doped region and provide for the second voltage to the N-doped region, the first and second voltages configured to polarize the P-doped region to a potential that is higher a potential of the N-doped region,
provide for the third voltage at the third electrode to generate a first potential barrier in a first channel area in the silicon layer at the first gate structure via the electrolyte solution, the first potential barrier opposing a passage of charge carriers emitted from the P-doped region, and
provide for the fourth voltage at the fourth electrode to generate a second potential barrier in a second channel area in the silicon layer at the second gate structure, the second potential barrier opposing a passage of charge carriers emitted from the N-doped region.

11. The biosensor system according to claim 8, wherein the controller comprises a current sensing device and a timing device, wherein
the current sensing device configured to sense or measure the current between the P-doped and N-doped regions, and
the timing device is configured to measure or determine the time difference between an application of the first voltage to the first electrode and the predetermined current variation of the current flowing between the P-doped and N-doped regions, the predetermined current variation caused by gradual accumulation of charge carriers in a first channel area in the silicon layer at the first gate structure and in a second channel area in the silicon layer at the second gate structure, leading to a disappearance of the first and second potential barriers.

12. The biosensor system according to claim 8, further comprising:
a second TRISFET including,
a second silicon layer,
a second P-doped region in the second silicon layer and a firth electrode in electric connection with the second P-doped region,
a second N-doped region in the second silicon layer and a sixth electrode in electric connection with the second N-doped region, a second general channel area defined in the second silicon layer between the second P-doped and N-doped regions,
a third gate structure including a third insulating layer on the second silicon layer, and a seventh electrode in contact with the third insulating layer; and
a fourth gate structure forming a second sensing area, the fourth gate structure including a fourth insulating layer on the second silicon layer, the second sensing area configured to receive a second electrolyte solution, and an eighth electrode at the second sensing area configured to be in contact with the second electrolyte solution, and
wherein the controller in further in operative connection with the fifth, sixth, seventh, and eighth electrodes via a connection wirings, respectively,
wherein the controller is further configured to provide for a fifth, sixth, seventh, and eighth voltage to the fifth, sixth, seventh, and eighth electrodes, respectively, and configured to determine a time difference between an application of the fifth voltage to the fifth electrode and a second predetermined current variation of a second current flowing between the second P-doped and N-doped regions.

13. The biosensor system according to claim 8, wherein the controller is configured to sense a current flowing between the N-doped and the P-doped region.

14. The biosensor system according to claim 8, wherein the third voltage applied to the third electrode is larger than zero, and the fourth voltage applied to the fourth electrode is smaller than zero.

15. The biosensor system according to claim 8, wherein the TRISFET further includes a second sensing area that includes a third insulating layer in contact with the second electrode, the second sensing area configured to receive a second electrolyte solution, and a fifth electrode configured to be in contact with the second electrolyte solution,
wherein the controller in is operative connection with the fifth electrode via a connection wiring.

16. A biosensor system comprising:
a TRISFET according to claim 2,
a second TRISFET including,
a second silicon layer,
a second P-doped region in the second silicon layer and a firth electrode in electric connection with the second P-doped region,
a second N-doped region in the second silicon layer and a sixth electrode in electric connection with the second N-doped region, a second general channel area defined in the second silicon layer between the second P-doped and N-doped regions,
a third gate structure including a third insulating layer on the second silicon layer, and a seventh electrode in contact with the third insulating layer; and
a fourth gate structure forming a second sensing area, the fourth gate structure including a fourth insulating layer on the second silicon layer, the second sensing area configured to receive a second electrolyte solution, and an eighth electrode at the second sensing area configured to be in contact with the second electrolyte solution, and
a controller in operative connection with the first, second, third, and fourth electrodes via a connection wiring of the TRISFET, respectively, and further in operative connection with the fifth, sixth, seventh, and eighth electrodes via a connection wirings of the second TRISFET, respectively,
wherein the controller is configured to determine a time difference between a predetermined current variation of a current flowing between the P-doped and N-doped regions and a second predetermined current variation of a second current flowing between the second P-doped and N-doped regions.
